(19) United States
(12) Patent Application Publication
(10) Pub. No.: US 2022/0108571 A1
(43) Pub. Date: Apr. 7, 2022

(54) CAR ACCIDENT TRACKING AND MARKING DEVICE

(71) Applicants: Sheng-Hung Pai, Taipei City (TW); JIA-MIN LIN, Taipei City (TW)

(72) Inventors: Sheng-Hung Pai, Taipei City (TW); JIA-MIN LIN, Taipei City (TW)

(21) Appl. No.: 17/444,392

(22) Filed: Aug. 4, 2021

(30) Foreign Application Priority Data
Oct. 1, 2020 (TW) 109213006

(51) Int. Cl. G07C 5/08

(52) U.S. Cl. CPC G07C 5/0825; G07C 5/085

(57) ABSTRACT

This inventive device is a marking and recording device for car accidents. The device comprises: 2 components: a mechanical marking component to mark the road, an automatic control component controlling all components. This device manually or automatically marks the velocity and trajectory of an out-of-control vehicle, so personnel wouldn't have to mark the accident in dangerous conditions and therefore prevent another accident from happening.

### FIELD

A marking and recording device, and more particularly relates to marking and recording the position and velocity of an out-of-control vehicle. When a vehicle is in said state, the driver can either manually activate said device or have said device automatically mark and record the position and velocity, substituting personnel marking the position and velocity by hand on the road and therefore decrease the chance of causing a second accident (hereinafter, device).

### PRIOR ART

Whenever a car accident happens, we need to investigate the causes. Not only does it help clarify the responsible party and resolve insurance reimbursement problems, but it also prevents accidents from happening again. At the moment of the accident, because things move quickly it is very hard to figure out what happened from a first party recount, although dash cams can help reconstruct what happened, due to camera angle restrictions and distance restrictions some errors may occur. Subsequently in some places, in order to investigate how it happened and figure out who's the responsible party, the location of the vehicle must be marked. But prior technology requires personnel to mark them by hand with chalk or paint, causing them to be exposed on roads and roadways and increase the possibility of a second accident to occur.

### SUMMARY OF THE INVENTION

In order to solve the problem described in prior art, personnel and even other drivers may be exposed to danger while said personnel are manually marking the scene of the car accident, this inventive device is invented. This inventive device, comprising: a mechanical marking component; an automatic control component, each component is coupled with each other, wherein said mechanical marking component is comprised: a control valve module, a pressure valve module, a conduit module, a quick-release module, each module are connected to each other by the quick-release module, the control valve module is coupled with the automatic control component, replacing manual marking with mechanical marking. so personnel wouldn't have to mark the accident in dangerous conditions such as freeways, causing another accident in the process, and save themself or help the wounded to a safer place. The mechanical marking component sends the instruction through the communications module of the automatic control component to the control valve module of the mechanical marking component, control valve module will open or close depending on the instruction, when the control valve module opens, the chemical marking substances in the pressure valve module travels through the quick-release module into the conduit module, and lastly discharges via the conduit module. The control valve module closes when the communications module of the automatic control component sends the signal to close, the chemical marking substance in the pressure valve module will be blocked because of the closure of the control valve module, causing the conduit module to stop functioning and subsequently stops discharging chemical marking substances.

Furthermore, to solve the inaccuracies accompanied with personnel manually marking the site, causing erroneous records and oversight, this inventive device provides an automatic solution to mark the velocity and position of the vehicle, customizing the code to different laws and regulations of different countries, accurately marking accidents in every country in accordance to local regulations. This inventive device, wherein the automatic control component comprising a computation module, a communication module, a data storage module and a manually activated button module, each module is coupled with each other in order to complete automation and replace manual marking. The communication module receives data of operation status of the vehicle and the signal from the manual button, immediately transfers it to the computation module to calculate, after which it orders the communication module to send a signal to the control valve module of the mechanical marking component to open and close. In addition, in the case of a pileup, the Vehicle Identification Number (VIN) embedded in the chemical marking substance can isolate each car's trajectory even after moving the cars to a safe place.

### LABELS

1: mechanical marking component
11: control valve module
12: pressure valve module
13: conduit module
14: quick-release module
2: automatic control component
21: computation module
22: communication module
23: data storage module
24: manually activated button module

### BRIEF DESCRIPTION OF THE DRAWINGS

FIG. 1 is an overall schematic of this invention.

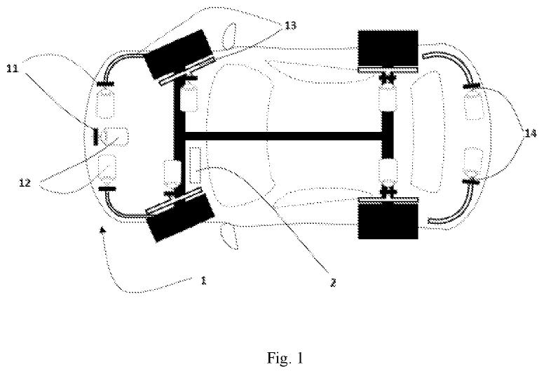

FIG. 2 is a flow chart illustrating the operation of the inventive system.

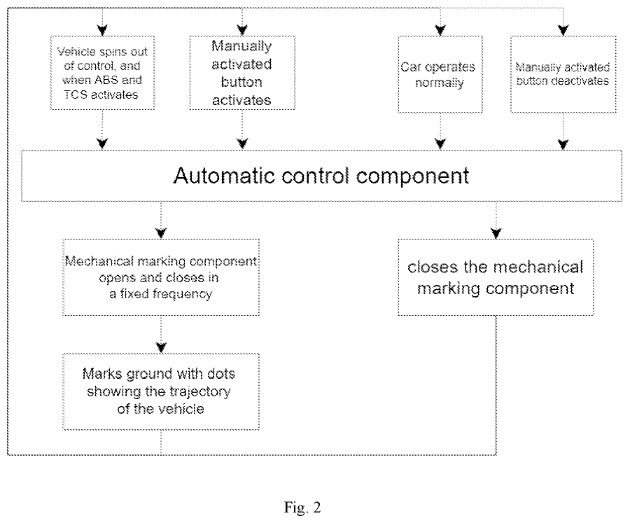

FIG. 3 is a flow chart illustrating the alternative operation of the inventive system.

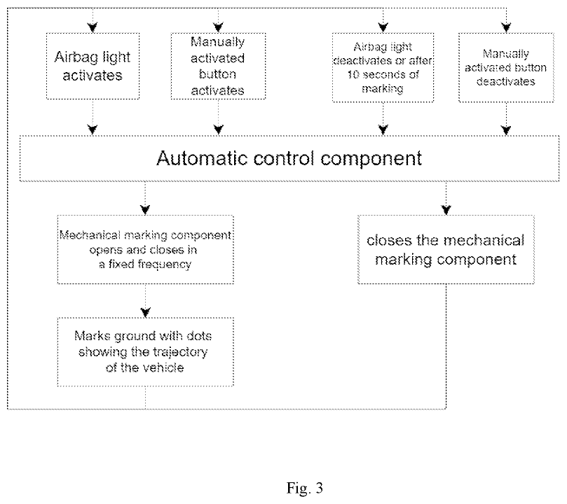

FIG. 4 is a representation of the mechanical marking component of the device.

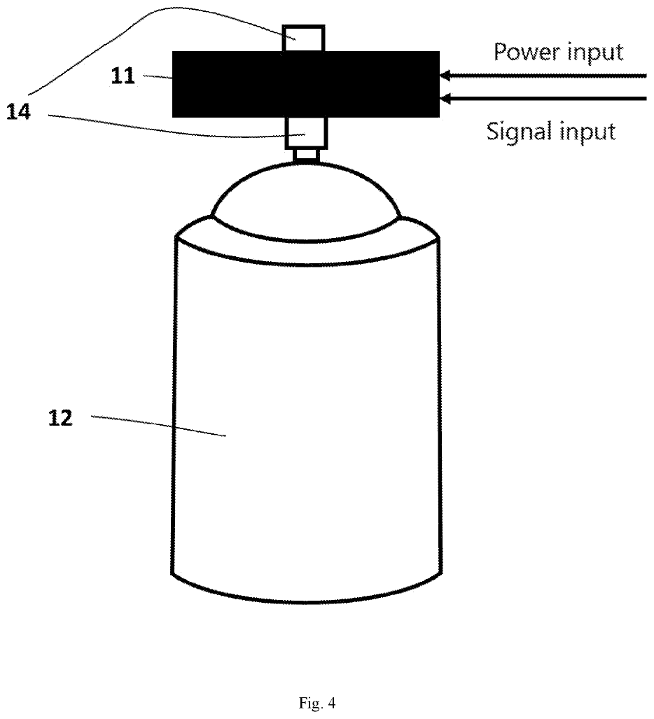

FIG. 5 is a representation of the automatic control component of the device.

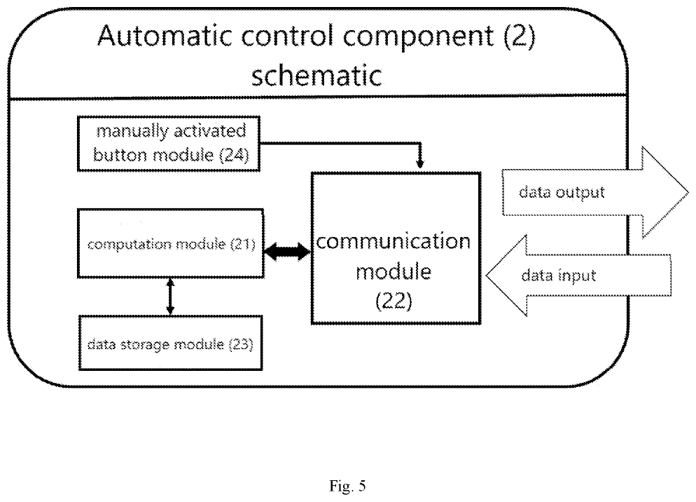

### SPECIFIC DESCRIPTION

Reference will now be made in detail to several embodiments of the invention that are illustrated in the accompanying drawings. Wherever possible, same or similar reference numerals are used in the drawings and the description to refer to the same component;

When the automatic control component (2) communications module (22) of this device receives the signal from the Anti-lock Braking System (ABS) and the Traction Control System (TCS) flashing for several seconds during the operation of a vehicle, automatic control component (2) communications module (22) sends the data to the data storage module (23) for storage purposes and also sends it to the computation module (21) for calculation, determine whether to mark the speed and trajectory of the vehicle. At the same time the results from the computation of the computation module (21), will be sent to the corresponding data storage module (23) and stored; if the results determine the need for marking then automatic control component (2) communications module (22), send a fixed frequency open and close command to the control valve module (11) of the mechanical marking component (1) to open and close in a fixed frequency, lastly the conduit module (13) emits the marking chemical on the ground in a fixed frequency dot pattern until the vehicle resumes normal operation or to a complete stop, through calculations of the number of and the frequency of the dots we can precisely obtain a record of the trajectory of the out-of-control vehicle; if the calculations results indicate no need for further marking, computation module (21) continues to receive data from the communications module (22) and calculate the data; but in special occasions or emergency situations, drivers can press the manually activated button module (24) any to order an interruption, causing the mechanical marking component (1) to be controlled by the driver, forcibly stopping the functions of the automatic control component (2).

Alternative operation: Whenever the automatic control component (2) communications module (22), receives the signal from the safety airbag activating, the automatic control component (2) communications module (22) sends the data to the data storage module (23), at the same time also sends the data to the computation module (21), after calculations the computation module (21) orders to begin marking the speed and trajectory as one kind of marking and the location of the crash as another kind of marking, and sends the results to the data storage module (23) for storing purposes, at the same time automatic control component (2) communications module (22) sends the instruction to open to the control valve module (11) of mechanical marking component (1, and lastly continuously spraying chemical marking through the conduit module (13) in a linear fashion or in dots, and will stop doing so until after a few seconds the vehicle stops, we can deduct from the marking on the ground the place where the vehicle stopped. If the vehicle is struck the second time, or when the vehicle starts moving again the automatic control component (2) communications module (22) sends the instruction to open, and will stop doing so until after a few seconds the vehicle stops, if it's a minor accident that did not trigger the airbag and the vehicle must be moved to the side of the road, drivers can press the manually activated button module (24) any to order an interruption, causing the mechanical marking component (1) to be controlled by the driver, forcibly stopping the functions of the automatic control component (2).

1. A vehicle accident trajectory marking device, comprising:
a mechanical marking component, and
an automatic control component with each module coupled with each other to achieve full effectiveness.

2. The vehicle accident trajectory marking device according to claim 1, wherein said mechanical marking component, comprising: a control valve module; at least a pressure valve module; at least a conduit module; at least a quick-release module; each module is coupled with each other to achieve full effectiveness.

3. The vehicle accident trajectory marking device according to claim 2, wherein each end of the control valve module of the mechanical marking component connects to the pressure valve module and the conduit module, the control valve module can open and close, the calculation results are sent to the communications module of automatic control component through the computation module, sends the instruction through the communications module to the control valve module, the control valve module opens or close depending on the instruction.

4. The vehicle accident trajectory marking device according to claim 2, wherein the pressure valve module of said mechanical marking component may contain chemical marking substances, when the control valve module opens the chemical marking substance go through the quick-release module, control valve module and finally comes out via the conduit module due to high pressure, when the conduit module closes the chemical marking substance will be blocked and unable to go through the conduit module, in addition the contents of the chemical marking substance is connected to the Vehicle Identification Number (VIN).

5. The vehicle accident trajectory marking device according to claim 2, wherein the conduit module of said mechanical marking component is used for transporting the chemical marking substance, not limited to additional exposed tubing outside of the vehicle.

6. The vehicle accident trajectory marking device according to claim 2 wherein the quick-release module of said mechanical marking component is responsible for attaching and detaching modules.

7. The vehicle accident trajectory marking device according to claim 1 wherein said automatic control component comprises: a computation module; a communications module; a data storage module; a manual button module; each module is coupled with each other to achieve full effectiveness.

8. The vehicle accident trajectory marking device according to claim 7, wherein the computation module of said automatic control component is responsible for computing data sent from the communications module, and sending the results to the data storage module and communications module respectively.

9. The vehicle accident trajectory marking device according to claim 7, wherein the communications module of said automatic control component is responsible for receiving data from the vehicle and data from the manually operated button, and also responsible for sending the results from the computation module, the sending and receiving of the communication module utilizes typical communication standards.

10. The vehicle accident trajectory marking device according to claim 7, wherein said manually activated button of the automatic control component is responsible for manually interrupting the automatic control component in special occasions or emergency situations, when a car is sent in for a tune up the manually operated button can be turned off temporarily upon request and if the driver encounters a problem and requires outside help, the driver can also manually activate the module to attract attention, but not limited to above mentioned scenario.
